(19) United States
(12) Patent Application Publication
(10) Pub. No.: US 2025/0304377 A1
(43) Pub. Date: Oct. 2, 2025

(54) CONVEYOR SKIRTING REMOVAL SYSTEM

(71) Applicant: CPC ENGINEERING PTY LTD, West Perth, Western Australia (AU)

(72) Inventors: Graham Trevor WARNER, Wellard (AU); Joshua WARNER, Wellard (AU); Brad Michael John LLOYD, Ellenbrook (AU)

(73) Assignee: CPC ENGINEERING PTY LTD, West Perth, Western Australia (AU)

(21) Appl. No.: 18/863,764

(22) PCT Filed: May 5, 2023
(86) PCT No.: PCT/AU2023/050378

§ 371 Date: Nov. 7, 2024

(30) Foreign Application Priority Data
May 9, 2022 (AU) 2022901234

(51) Int. Cl. B65G 21/20

(52) U.S. Cl. CPC B65G 21/2081; B65G 2207/48

(57) ABSTRACT

The present invention relates to a conveyor skirting removal system, the system comprising: a framework; at least one skirting panel releasably fixed to the framework; at least one set of support brackets, each support bracket comprising a rotation assembly and a horizontal arm extending laterally from the framework; and at least one set of mounting members fixed to the skirting panel, each mounting member comprising a lower portion and an upper portion; wherein the lower end of each mounting member is configured to engage with the rotation assembly of one of the support brackets and the engagement permits rotational movement of the skirting panel to a position where the upper portion of each mounting member abuts the horizontal arm of one of the support brackets.

### TECHNICAL FIELD

The present invention relates to a conveyor skirting removal system. More preferably, the conveyor skirt system of the present invention is intended to allow for the replacement of the conveyor skirt liner without the need for an operator inside the conveyor transfer area.

### BACKGROUND ART

The following discussion of the background art is intended to facilitate an understanding of the present invention only. The discussion is not an acknowledgement or admission that any of the material referred to is or was part of the common general knowledge as at the priority date of the application.

In order to transfer bulk materials a conveyor system is often used. Such conveyor systems comprise a belt that extends in a continuous loop around rollers and pulleys. The upper portion of the loop can be referred to as a transfer area and the lower portion of the loop can be referred to as a return run. Bulk material is loaded onto the transfer area and is carried along by the conveyor system.

As the bulk material is typically particulate in nature, it is also common to heap the bulk material near the centerline of the belt, while keeping such bulk material from spilling off the edges of the belt. To prevent such spillage, most conveyor systems comprise rigid skirts that are provided along each edge of the transfer area for purposes of redirecting stray bulk material and retaining such material on the belt.

Because many types of bulk materials are abrasive, it is also common practice to attach wear liners to the skirts. In this manner, the wear liners prevent the direct contact of the skirts with the bulk material. Over time, the wear liners degrade from direct contact with the moving bulk material and periodically must be replaced.

Due to the fact that wear liners are mounted to the side of the skirt facing the center plane of the belt (the inward side), skirting replacement or maintenance is typically carried out by two work crews, one inside the chute/transfer area manipulating the liners in and out of place and the other crew outside chute/transfer area removing and replacing fasteners. Having an operator enter the chute/transfer area presents a significant safety risk.

Whilst several proposed solutions have been developed that seek to limit the amount of interaction required from inside the transfer area, there is often still a need for an operator to place their hands inside the transfer area, albeit from the outside, to replace components. This leads to difficulties in positioning the wear liners accurately and presents a risk of injury.

### SUMMARY OF INVENTION

In accordance with the present invention, there is provided a conveyor skirting removal system, the system comprising:
a framework;
at least one skirting panel releasably fixed to the framework;
at least one set of support brackets, each support bracket comprising a rotation assembly and a horizontal arm extending laterally from the framework; and
at least one set of mounting members fixed to the skirting panel, each mounting member comprising a lower portion and an upper portion;
wherein the lower end of each mounting member is configured to engage with the rotation assembly of one of the support brackets and the engagement permits rotational movement of the skirting panel to a position where the upper portion of each mounting member abuts the horizontal arm of one of the support brackets.

The system of the present invention is intended to allow for the inward face of the skirting panel to be accessed from the exterior of the conveyor. When required, the skirting panel is unfastened from the framework and the full weight of the skirting panel is supported on the support brackets. The engagement of the mounting members with the respective support bracket permits rotational movement of the skirting panel with respect to the framework. This will allow the skirting panel to move away from a substantially vertical orientation towards a substantially horizontal orientation. The rotation is limited by the abutment of the mounting members with the horizontal arms. This orientation will the inward face of the skirting panel to be accessed from outside the conveyor, thereby permitting service to the inward face. Once complete, the skirting panel may be rotated back towards a substantially vertical orientation and may be again fastened to the framework.

Preferably, each skirting panel has a wear liner attached thereto.

In one form of the present invention, each skirting panel comprises a front face and a rear face. When the skirting panel is mounted to the framework, the front face will face the conveyor. Preferably, the wear liner is attached to the front face.

It is envisaged that the conveyor skirting removal system of the present invention will allow for the simple replacement of the wear liners. In order to replace the wear liner, the skirting panel is unfastened from the framework and rotated on the support brackets. This will present the front face of the skirt panel to an operator on the exterior of the conveyor, allowing replacement of the wear liners.

In one form of the present invention, a set of support brackets is mounted to the framework at the location of each skirting panel. In an alternative form of the present invention, the set of support brackets is releasably mounted to the framework. This form of the present invention allows the set of support brackets to be relocated adjacent to the skirting panel being removed.

In one form of the present invention, the set of mounting members are releasably mounted to the rear of the skirting panels. This embodiment allows for the set of the mounting members to be mounted on the adjacent skirting panels on either side of the skirting panel being removed.

In an alternative form of the present invention, a set of mounting members is fixed to each skirting panel. In an alternative form of the present invention, the set of mounting members is releasably fixed a skirting panel. This form of the present invention allows the set of mounting members to be relocated to the skirting panel being removed.

In one form of the present invention, each support bracket comprises a rotation assembly. Preferably, the rotation assembly is configured to permit rotational movement of the skirting panel relative to the framework to a position where the upper portion of each mounting member abuts the horizontal arm of one of the support brackets. More preferably, the rotation assembly will permit the skirting panel to be rotated between a substantially vertical orientation and a substantially horizontal orientation. In one form of the present invention, the lower portion of each mounting member comprises a rotation member configured to engage the rotation assembly.

In one form of the present invention, the rotation assembly comprises a pivot aperture configured to engage with a pin. Preferably, the lower portion of each mounting member comprises a pin configured to co-operate with the pivot aperture. In one form of the present invention, the pin is integrally formed with the lower portion of the mounting member. In an alternative form of the present invention, the mounting member comprises a pivot aperture and a pin is disposed through both the rotation assembly pivot aperture and the mounting member pivot aperture.

In an alternative form of the present invention, the rotation assembly comprises a pivot surface about which the mounting member may rotate. Preferably, each mounting member comprises one or more teeth configured to engage with the pivot surface. More preferably, the teeth engage with the pivot surface when the skirting panel is unfastened. Still preferably, the engagement of the pivot surface and the teeth permit the mounting member to be rotated about the pivot surface.

In one form of the present invention, each mounting member comprises an upper end. Preferably, the upper end is configured to abut the horizontal arms.

In one form of the present invention, the support brackets are configured to permit movement of the mounting members along the horizontal arm. This embodiment will allow the skirting panel to be moved laterally away from conveyor, providing improved access to the front face of the skirt panel.

In one form of the present invention, the horizontal arm comprises a slide assembly. Preferably, the slide assembly comprises a carriage mounted on a linear rail. In this embodiment of the present invention, the mounting members are supported on the carriage. Once engaged, the carriage and skirting panel can slide along the linear rail.

In an alternative form of the present invention, the horizontal arm comprises a linear gear. Preferably, the mounting members comprise a circular gear configured to engage with the linear gear.

In one form of the present invention, each support bracket further comprises a vertical arm fixed to the horizontal arm. Preferably, each support bracket further comprises a third arm fixed diagonally between the horizontal arm and the vertical arm.

Preferably, the framework comprises an upper support member configured to abut an upper edge of the skirting panel. More preferably, the upper edge of the skirting panel is releasably fixed to the upper support member.

In one form of the present invention, an upper flange is provided on the rear face of each skirting panel. Preferably, each skirting panel is releasably fixed to the support member by way of the upper flange. More preferably, a lower flange is provided on the support member to co-operate with the upper flange of the skirting panel. Still preferably, one or more fastening means are provided through the lower flange on the support member and the upper flange of the skirting panel. Still preferably, the one or more fastening means are nuts and bolts.

In one form of the present invention, a clamping bracket is mounted across adjacent skirting panels. Preferably, the clamping bracket is fixed to the rear face of the skirting panels. Still preferably, the rear face may be provided with mounting location to which the clamping bracket may be fixed to. In embodiments where the mounting members are releasably fixed to the skirting panel, it is envisaged that they may be mounted on the mounting location of the skirting panel to be removed. In embodiments where the support brackets are releasably fixed to the framework, it is envisaged that they may be mounted on the mounting locations of the skirting panels adjacent to the skirting panel to be removed.

In one form of the present invention, conveyor skirting removal system further comprises an actuation means configured to rotate the skirting panel. Preferably, the actuation means is a lever fixed to the rear of the skirting panel.

In one form of the present invention, at least one of the support brackets comprises a locking assembly configured to restrict rotation of the skirting panel from a horizontal position to a vertical position. Preferably, the locking assembly may be disengaged to permit rotation of the skirting panel from a horizontal position to a vertical position.

In accordance with a second aspect of the present invention, there is provided a method for using conveyor skirting removal system as described above to replace a wear liner on a skirting panel of a conveyor.

In accordance with a third aspect of the present invention, there is provided a system for removing skirting panels from a conveyor, the system comprising:
at least one set of support brackets releasably mountable to a framework of the conveyor, each support bracket comprising a rotation assembly and a horizontal arm extending laterally from the framework; and
at least one set of mounting members releasably mountable to a rear face of a skirting panel, each mounting member comprising a lower portion and an upper portion;
wherein the lower end of each mounting member is configured to engage with the rotation assembly of one of the support brackets and the engagement permits rotational movement of the skirting panel to a position where the upper portion of each mounting member abuts the horizontal arm of one of the support brackets.

The system according to third aspect of the present invention is intended to be relocated to each skirting panel as required. In order to remove a skirting panel, the set of mounting members are mounted on the skirting panel. The set of support brackets are mounted to the framework at a position suitable to engage the mounting members.

In accordance with a fourth aspect of the present invention, there is provided a method for replacing a wear liner on a skirting panel of a conveyor, the method comprising the steps of:
engaging the system according to the third aspect of the present invention with the skirting panel;
unfastening the skirting panel from a framework of the conveyor;
rotating the skirting panel from a vertical orientation to a horizontal orientation;
replacing the wear liner;
rotating the skirting panel from a horizontal orientation to a vertical orientation; and
fastening the skirting panel to the framework.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is an upper perspective view of the conveyor skirting removal system in accordance with one embodiment of the present invention with the skirting panel in a vertical orientation;

FIG. 2 is an upper perspective view of the conveyor skirting removal system of FIG. 1 with the skirting panel being rotated;

FIG. 3 is an upper perspective view of the conveyor skirting removal system of FIG. 1 with the skirting panel in a horizontal orientation;

FIG. 4 is an upper rear perspective view of a set of support brackets in accordance with one embodiment of the present invention;

FIG. 5 is an upper rear perspective view of a set of mounting members in accordance with one embodiment of the present invention;

FIG. 6 is a detailed view of the rotation assembly of FIG. 1;

FIG. 7 is a detailed view of the rotation assembly of FIG. 2;

FIG. 8 is a detailed view of the rotation assembly of FIG. 3;

FIG. 9 is a side view of a rotation assembly in accordance with a further embodiment with the skirting panel in a vertical orientation;

FIG. 10 is a side view of a rotation assembly of FIG. 9 with the skirting panel;

FIG. 11 is an upper perspective view of the conveyor skirting removal system in accordance with an alternative embodiment of the present invention with the skirting panel in a vertical orientation;

FIG. 12 is an upper rear perspective view of a set of support brackets in accordance with the embodiment shown in FIG. 11;

FIG. 13 is side view of the conveyor skirting removal system of FIG. 11 during rotation of the skirting panel;

FIG. 14 is an upper rear perspective view of a set of mounting members in accordance with the embodiment shown in FIG. 11;

FIG. 15 is an upper rear perspective view of a support bracket in accordance with a further embodiment of the present invention; and

FIG. 16 is a side view of the support brackets of FIG. 15.

### DESCRIPTION OF EMBODIMENTS

Throughout this specification, unless the context requires otherwise, the word “comprise” or variations such as “comprises” or “comprising”, will be understood to imply the inclusion of a stated integer or group of integers but not the exclusion of any other integer or group of integers.

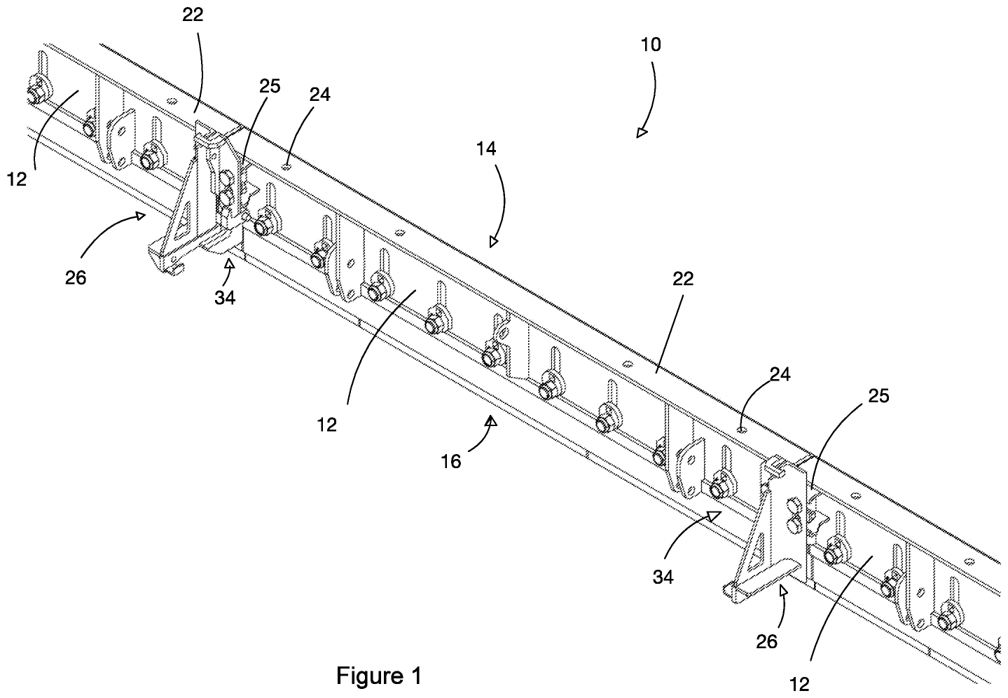

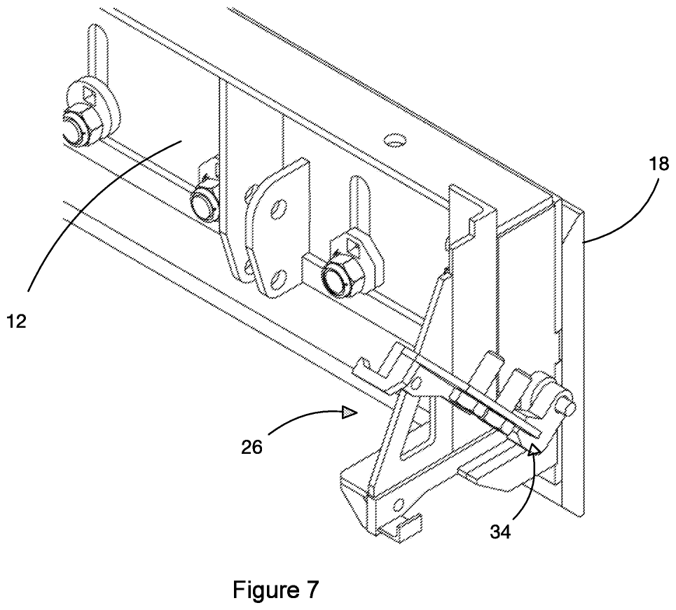

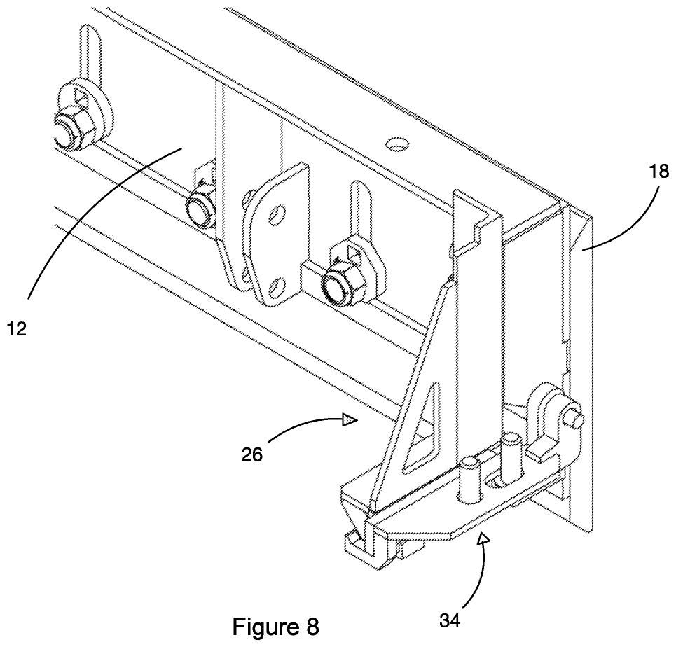

In FIGS. 1-8 there is shown a conveyor skirting removal system 10 in accordance with the present invention. The conveyor skirting removal system 10 is adapted to be used in association with a conventional conveyor (not shown). The conveyor comprises a belt that extends in a continuous loop around rollers and pulleys in the known manner. An upper portion 38 of the loop can be referred to as a transfer area. Bulk material (not shown) is loaded onto the transfer area and is carried along the conveyor by the belt.

As the bulk material is typically particulate in nature, it is necessary to ensure that the bulk material does not spill from the edge of the belt. To prevent such spillage, the conveyor skirting removal system 10 is positioned along the sides of the transfer area. The conveyor skirting removal system 10 acts to prevent or at least inhibit the migration of the bulk material outwardly from the transfer area.

The conveyor skirting removal system 10 comprises a series of skirting panels 12. Each skirting panel 12 has a front face 14 directed towards the transfer area. Similarly, each skirting panel 12 has a rear face 16. A wear liner 18 is fixed to the front face 14 of each skirting panel 12. The wear liner 18 is mounted on each skirting panel 12 by fasteners, such as bolts. The skirting panels 12 are positioned such that a bottom edge 20 of each skirting panel 12 is close to the belt. Whilst some small bulk material may pass under the skirting panels 12, such material is prevented from escaping from the transfer area by a rubber seal (not shown) positioned behind the rear face 16.

A framework (not shown) is positioned alongside the conveyor 12. The framework is a stationary structure to which skirting panels may be fixed. The framework is arranged such that the skirting panels 12 are supported in their position adjacent to the conveyor 12 when fixed to the framework. The framework comprises an upper support member configured to abut the upper edge of the skirting panel 12. It is envisaged that the upper support member could be any solid member capable of supporting the skirting panels 12. Such members include, for example, unitary beams. The upper support member would also be in the form of a series of upper skirting panels.

The rear face 16 of the skirting panels 12 are provided with an upper flange 22 along the length of the top edge. In the embodiment shown in the Figures, the upper flange spans the entire width of the skirting panels 12. A number of apertures 24 are provided through the upper flange 22 to facilitative the mounting of the skirting panels 12 to the upper support member. The upper support member is preferably provided with a co-planar flange which co-operates with the upper flange.

Both the upper flange and the upper support member are provided with a number of apertures facilitate bolts to fasten the skirting panels 12 to the upper support member. It is envisaged that the embodiment shown in the Figures is particularly useful as it allows the skirting panels 12 to be unfastened from outside the transfer area. Advantageously, this allows the skirting panels 12 to be unfastened without requiring access to the inside of the transfer area. Other fixing arrangements known to those skilled in the art could be utilised to fix the skirting panels 12 to the upper support member. Important to the functioning of the present invention is the ability to unfasten the skirting panels 12 from the upper support member when required.

Adjacent skirting panels 12 are arranged so the sides abut one another when fastened to the upper support member. This provides a continuous front face 14 along the length of the conveyor. In the embodiment shown in the figures, adjacent skirting panels 12 are fixed to one another using clamping brackets (not shown) that are fixed to the rear face 16 of the skirting panels 12 such they span across adjacent skirting panels 12. The clamping brackets are preferably constructed from a flat unitary body piece. The rear face 16 of each skirting panel is provided with a mounting location 25 which is configured to allow the clamping brackets to be fastened to. In the embodiment shown in the figures, the mounting location 25 comprises two threaded receptacles which allow the clamping bracket to be bolted to the rear face 16 of the skirting panel 12.

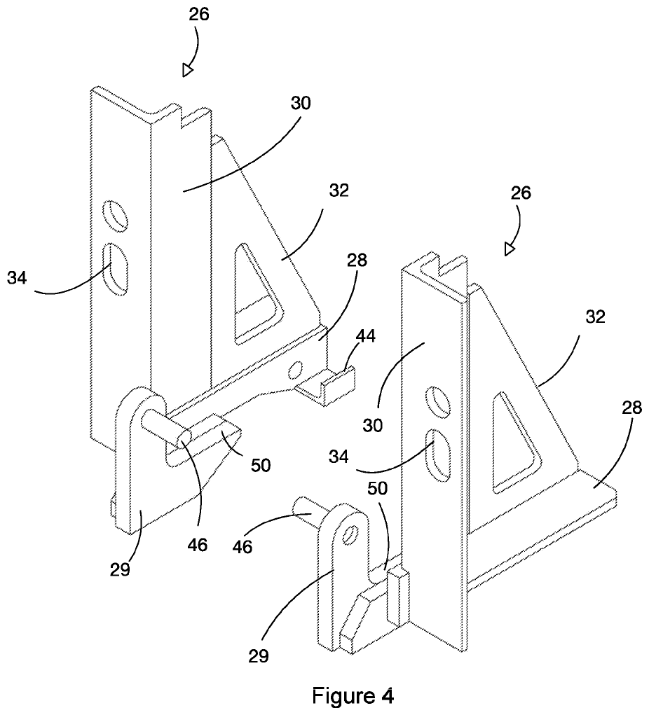

The conveyor skirting removal system 10 further comprises one or more sets of support brackets 28. A detailed view of the support brackets 26 is shown in FIG. 4. Each support bracket 28 comprises a horizontal arm 28 which projects laterally from the conveyor in a direction perpendicular to the elongate axis of the skirting panels 12 and substantially parallel to the ground. Each support bracket 28 further comprises a rotation assembly 29, which is described in more detail below. The individual support brackets 26 are mounted at locations adjacent to the side edges of the skirting panels 12. In the embodiment shown in the figures, the support brackets 26 further comprise a vertical arm 30 fixed to the horizontal arm 28 and a third arm 32 fixed diagonally between the horizontal arm 28 and the vertical arm 30. In the embodiment shown in the figures, the support brackets 28 are mountable at the vertical arm 30 and suitable apertures 34 are provided in the vertical arm 30. Each of the vertical arm 30 and the third arm 28 provide additional strength to the support brackets 26. It is envisaged that any means of providing additional strength to the horizontal arm 28 may be incorporated.

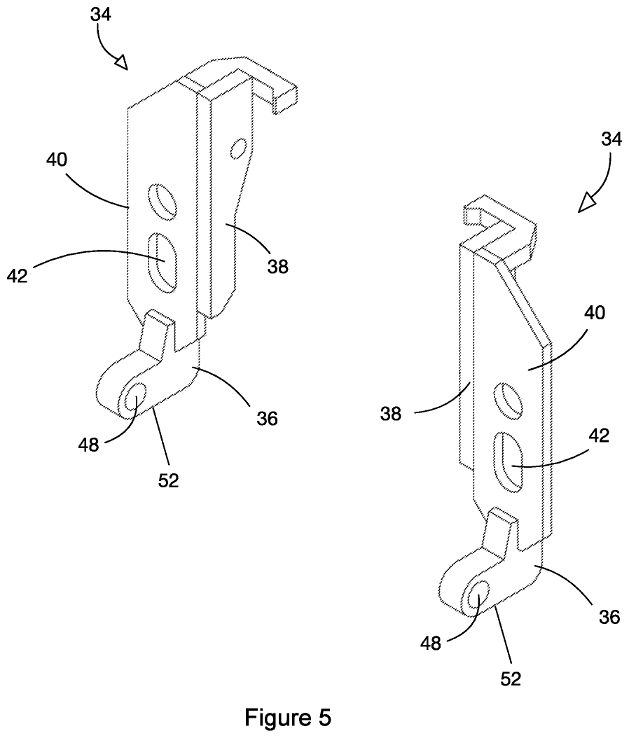

The conveyor skirting removal system 10 further comprises one or more sets of mounting members 34 fixed to the skirting panel 12. A detailed view of the mounting members 34 is shown in FIG. 5. Each mounting member 34 is configured to engage with a respective support bracket 26. The location and orientation of the mounting members 34 is driven by the mounting position of the respective support bracket 26. In the embodiment shown in the figures, the mounting members 34 are fixed to either side of the skirting panel 12. This allows stable support of the skirting panel 12. The mounting members 34 and the support brackets 26 are configured such that at least a portion of the mounting members 34 engages the support brackets 26 when the skirting panel 12 is unfastened from the framework. As each side of the skirting panel 12 engages a support bracket 26, the skirting panel 12 is fully supported by the support brackets 26.

As best shown in FIG. 5, each mounting member 34 comprises a lower portion 36 and an upper portion 38. Each mounting member 36 is fixed to a skirting panel 12. A fixing plate 40 is provided to allow the mounting member 36 to be fixed to the skirting panel 12. Apertures 42 are provided through the fixing plate 40.

The set of support brackets 26 are positioned to engage with the mounting members 34. In the embodiment shown in the figures, the support brackets 26 are mounted to the skirting panels 12 adjacent to the skirting panel 12 to be removed. In this embodiment, the support brackets 26 are releasably mounted, thereby allowing them to be repositioned adjacent to the skirting panel 12 being removed. In the embodiment shown in the figures, the support brackets 26 are mounted to the adjacent skirting panel 12 at the mounting location 25 for the clamping bracket.

In an alternative embodiment of the present invention, the support brackets 26 are mounted to the framework. It is envisaged that a set of support brackets 26 may be mounted to the framework at the location of each skirting panel 12. Alternatively, the set of support brackets 26 may be releasably mounted to the framework, allowing the set of support brackets 26 to be relocated adjacent to the skirting panel 12 being removed.

In one embodiment of the present invention, a set of mounting members 34 is fixed to each skirting panel 12. In an alternative embodiment of the present invention, the set of mounting members 34 is releasably fixed to the skirting panel 12. This form of the present invention allows the set of mounting members 34 to be relocated to the skirting panel 12 being removed. In the embodiment shown in the figures, the mounting members 34 are fixed to the skirting panel 12 at the mounting location 25 for the clamping bracket.

The engagement of the mounting members 34 and the support members is such that the skirting panel 12 may be fully supported on the support brackets 26 when unfastened from the framework. Preferably, the lower portion 36 engages the rotation assembly 29 of a support bracket 26 when the skirting panel is unfastened from the framework. In addition to supporting the weight of the skirting panel 12 on the support arms, the engagement between the lower portion 36 and the rotation assembly 29 permits the rotation of the mounting members 34 with respect to the support brackets 26. This is turn permits the rotation of the skirting panel 12 with respect to the support brackets 26 and the framework.

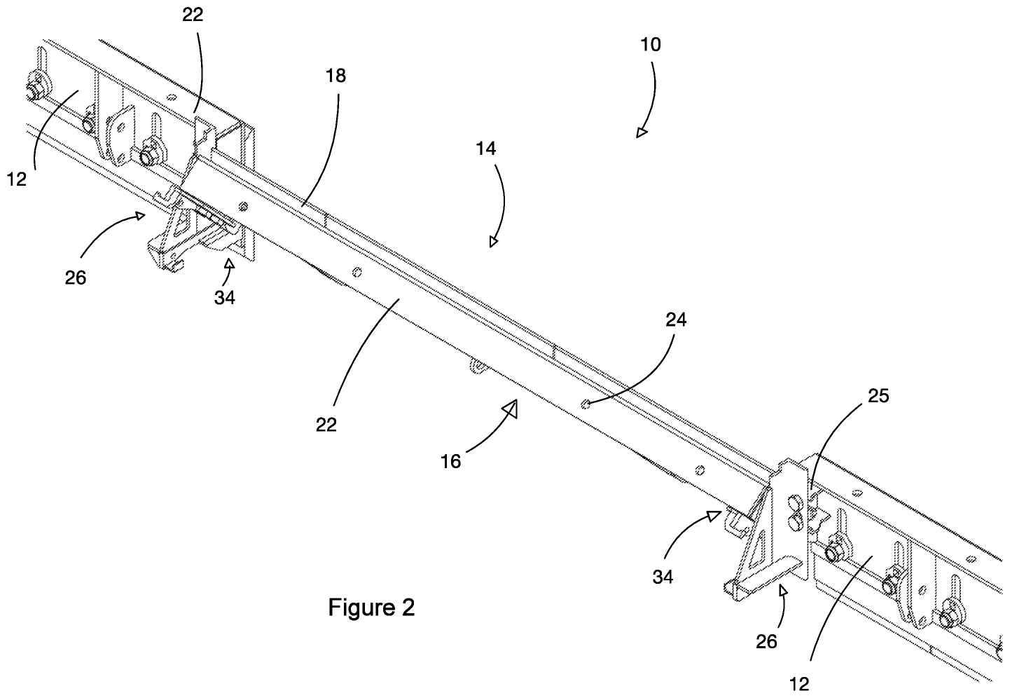

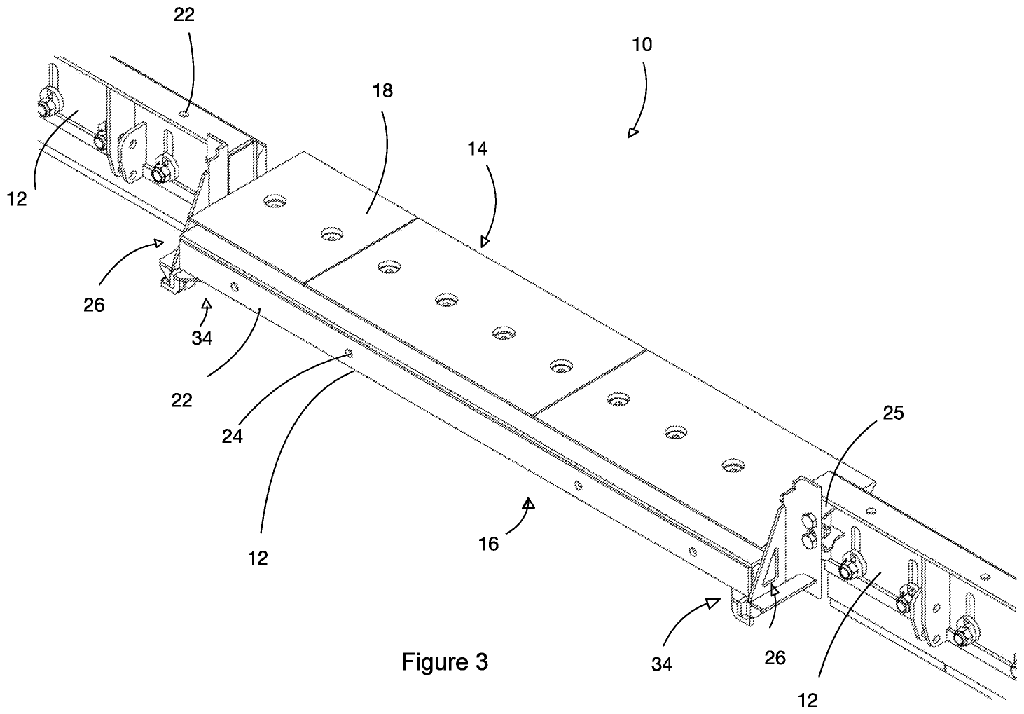

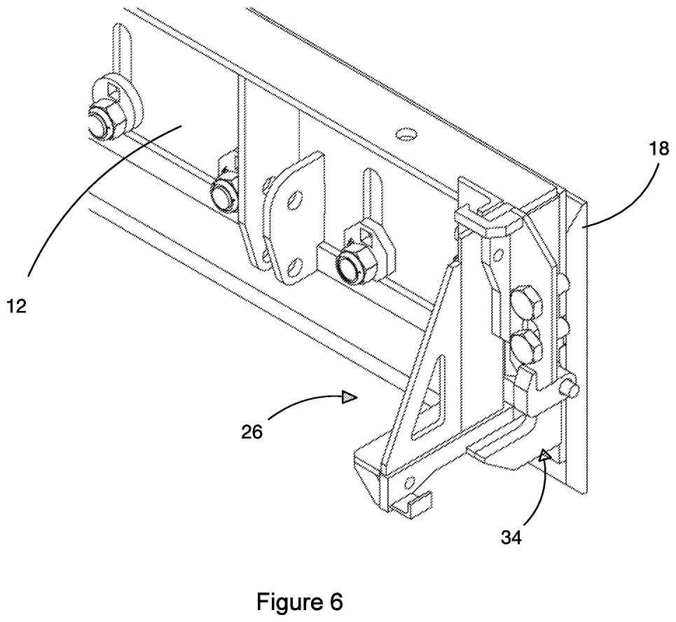

In normal use, the skirting panels 12 are fastened to the upper support member in a vertical orientation, with the front face 14 directed towards the conveyor. This orientation is shown in FIG. 1. The skirting panels 12 will remain in this vertical orientation when unfastened from the upper support member. As discussed above, the lower portions 36 of the mounting members 34 engage with the rotation assembly 29 of the respective support bracket 26. The engagement of the mounting members 34 and the support members permits rotational movement. This engagement in turn permits rotational movement of the skirting board with respect to framework and support brackets 26. This rotation will rotate the skirting panel 12 away from a substantially vertical orientation as shown in FIG. 2 and towards a substantially horizontal orientation as shown in FIG. 3. The rotation is limited by the abutment the upper portion 38 of the mounting members 34 with the horizontal arms 28. In this position, the weight of the skirting panel 12 is spread across the length of the horizontal arm 28. In this orientation, the front face 14 of the skirting panel 12 faces upwards. FIGS. 6, 7 and 8 show a more detailed view of the engagement between the mounting members 34 and the support brackets 26 in each of the skirting panel 12 orientations shown in FIGS. 1, 2, and 3. In these Figures, the skirting panel 12 has been removed to prevent occlusions.

To limit the rotation of the skirting panel, the upper portion 38 of the mounting members 34 engage with the horizontal arms 28. As best shown in FIG. 4, the horizontal arm 28 is provided with a flat support portion 44. The upper portion 38 of the mounting member 34 similarly comprises a flat section which rests on the support portion 44. Alternatively, a suitable support portion may extend along the length of the horizontal arm 28. Any arrangement between mounting member 34 and horizontal arm 28 that limits the rotation of the mounting members can similarly be used. A locking mechanism may also be used to retain the mounting members 34 in this position. For example, the locking mechanism could be a pin that is driven through the mounting member 34 and the horizontal arm 28.

The support brackets 26 each comprise a rotation assembly 29 configured to permit rotational movement with the mounting members 34. FIG. 4 shows a detailed view of a rotation assembly 29 in accordance with one embodiment of the present invention. In this embodiment, the rotation assembly comprises a pivot pin 46 which permits pivotal engagement with the mounting member 34. The lower portions 36 of the mounting members 34 are provided with a pivot point 48 through which the pivot pin 46 may be inserted. In the embodiments shown in the figures, the pivot pin 46 is integrally formed with the support brackets 26. In this embodiment, the pivot pin 46 is inserted into the pivot point 48 when the mounting member 34 is fixed to the skirting board. It is envisaged that the integrally formed pivot pin 46 could be replaced by a removable pivot pin inserted through the mounting member 34 and support bracket 26. Alternatively, the pivot pin 46 could be integrally formed with the mounting members 34 and the support brackets could be provided with the pivot points 48. To prevent the full weight of the skirting panel 12 being transferred through the pivot pin, the support bracket 26 is provided with a support portion 50. The support portion 50 is arranged to be directly underneath the mounting member 34. In this manner, the mounting member 34 will be lowered down onto the support portion as the skirting panel 12 is unfastened. The lower portion 36 may similarly be shaped to engage with the support portion 50, such as with a flat lower surface 52.

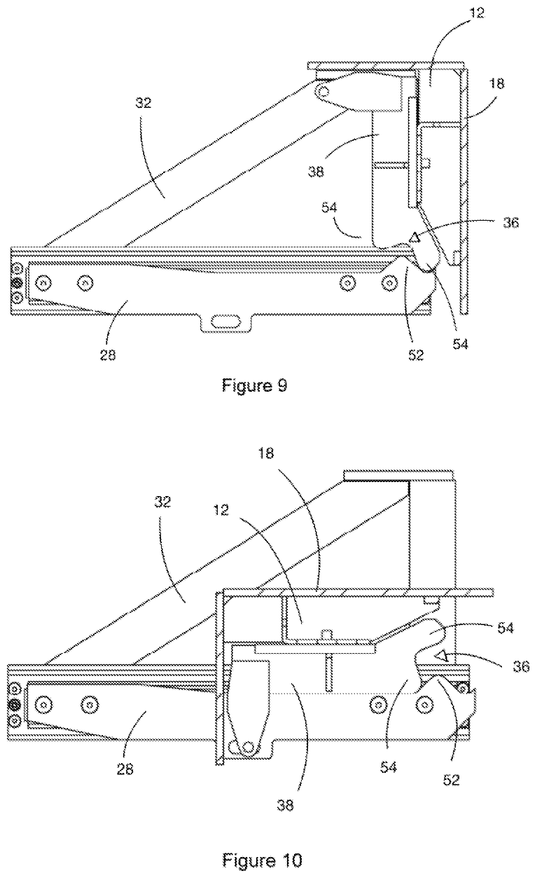

FIGS. 9 and 10 show a detailed view of a rotation assembly 29 in accordance with a further embodiment of the present invention. In this embodiment, the support bracket 26 is provided with a pivot surface 52. The lower portion 36 of the mounting member 34 is provided with two teeth 54 which are shaped to engage either side of the pivot surface 52. The support bracket 26 is positioned such that the teeth 54 engage and interlock with the pivot surface 52 when the skirting panel 12 is unfastened from the upper support member, as shown in FIG. 9. Once unfastened, the skirting panel 12 is free to be rotated about the pivot surface 52 to a horizontal orientation as shown in FIG. 10. The upper portion 38 similarly abuts the horizontal arm 28.

In one form of the present invention, the support brackets 26 are configured to permit movement of the mounting members 34 along the horizontal arm 28. This embodiment will allow the skirting panel 12 to be moved laterally away from conveyor, providing improved access to the front face 14 of the skirting panel 12. Preferably, the support brackets 26 comprise a linear track extending in the direction of the horizontal arm 28. In one embodiment, the liner track is provided in the form of a slide assembly which comprises a carriage mounted on a linear rail. In this embodiment, the linear rail is fixed to the support bracket 26 and the carriage is able to slide along the linear rail. The mounting members 34 will engage with the carriage, allowing the skirting panel 12 to be driven along the track. It is envisaged that similar means for permitting movement of the mounting members 34 along the horizontal arm 28 may be used. For example, track and roller assembly or a rack and pinion assembly.

The conveyor skirting removal system 10 further comprises an actuation means configured to rotate the skirting panel 12. In a preferred embodiment, actuation means is a pair of levers fixed to the rear face 16 of the skirting panels 12. Once unfastened from the upper support member, an operators may use the levers to rotate the skirting panel 12.

FIGS. 1-3 illustrate the use of the conveyor skirting removal system 10 of the present invention. A series of skirting panels 12 are fastened to a framework adjacent to the conveyor. Wear liners 18 are fastened to the front face 14 of the skirting panels 12. A set of mounting members 34 are fixed to the rear of the skirting panel 12. A set of support brackets 26 comprising a horizontal arm 28 are fastened to the framework. The support brackets 26 are positioned such that they are directly underneath the associated mounting member 34 of the skirting panel 12 and the lower portions 36 engage with the rotation assembly 29. Eventually, the wear liners 18 on the skirting panels 12 will need to be inspected, repaired or replaced. To complete this, the skirting panel 12 is unfastened from the upper support member. FIG. 1 shows the skirting panel 12 unfastened from the framework. Once unfastened, the full weight of the skirting panel 12 will be supported by the support brackets 26.

The skirting panel 12 may then be manually rotated such that the skirting panel 12 moves from a vertical orientation towards a horizontal orientation as shown in FIG. 3. In this orientation, the front face 14 is orientated upwards.

Once the necessary work has been completed, the skirting panel 12 is rotated back to a vertical orientation. The skirting panel 12 may then be again fastened to the upper support member.

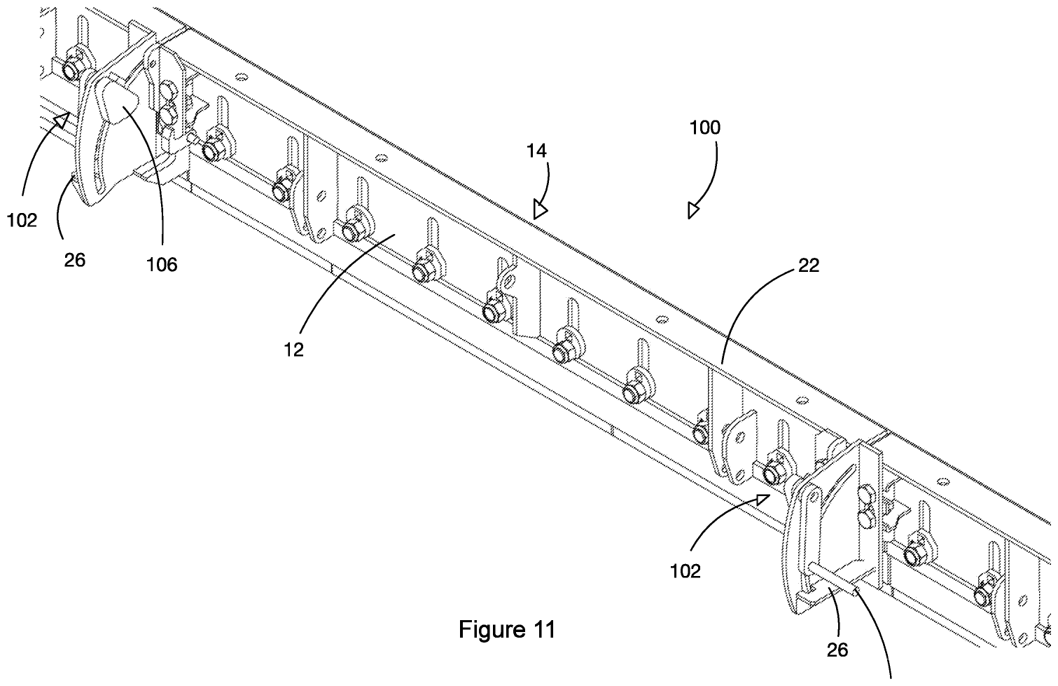

FIGS. 11-14 show a conveyor skirting removal system 100 in accordance with a further embodiment of the present invention. Conveyor skirting removal system 100 shares many similarities with conveyor skirting removal system 10 and like numerals denote like parts. Conveyor skirting removal system 100 comprises a locking assembly 102. As discussed above, the skirting panel 12 may be rotated from a vertical orientation to a horizontal orientation to rest on the horizontal arms 28. In this position, the wear liner 18 exerts a downward force on the skirting panel 12 to assist in retaining the skirting panel 12 in the horizontal orientation. The inventors have found that when the skirting panel 12 is rotated back towards the vertical orientation, either intentionally or unintentionally, the weight of the wear liner 18 caused an imbalance and the skirting panel 12 will snap back to the vertical orientation. This can present a safety risk. The locking assembly 102 is intended to allow the skirting panel 12 to be moved from a vertical orientation to a horizontal orientation, but restrict movement back to the vertical orientation until the locking assembly 102 is disengaged.

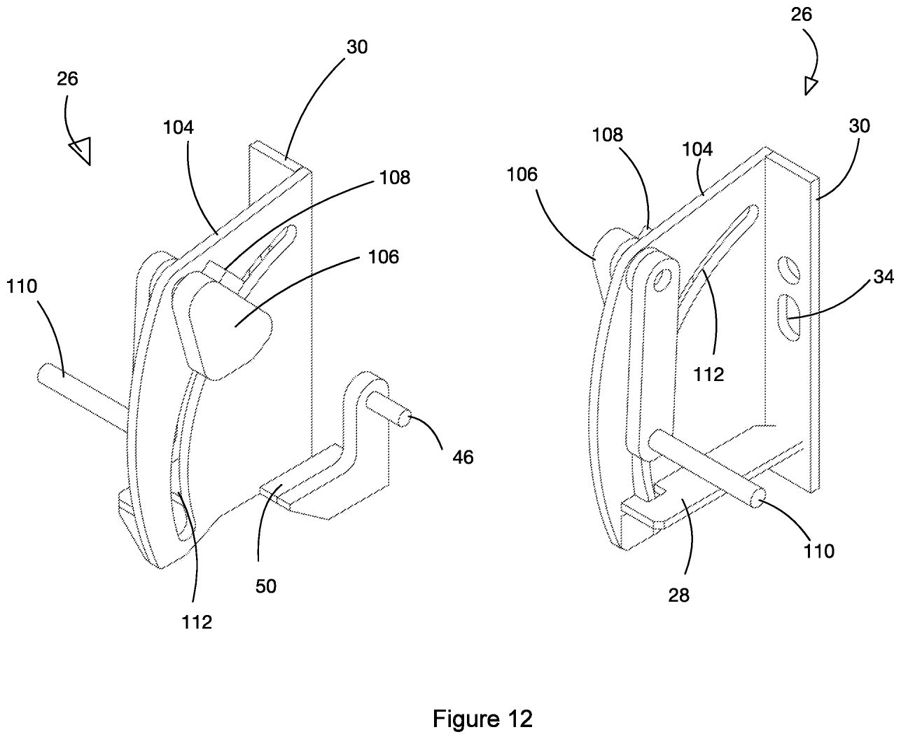

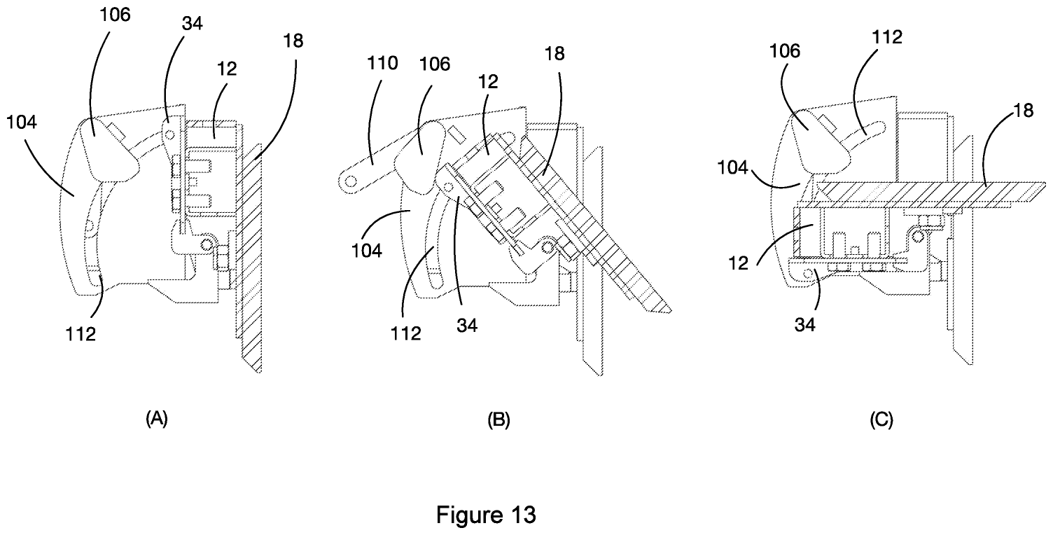

In the embodiment shown in FIGS. 11-14, the locking assembly is incorporated into the support brackets 26. An isolated view of the support brackets is shown in FIG. 12. In this embodiment, one or each of the support brackets further comprises a plate 104 fixed between the horizontal arm 28 and the vertical arm 30. The plate 104 is used to support the locking assembly 102 and provides a surface for it to be mounted on. In this embodiment, the locking assembly 102 comprises a striker 106 rotationally mounted to plate 104. The striker 106 is positioned such that a portion of the skirting panel 12 or mounting members 36 will impact the striker 106 as the skirting panel is moved from a vertical orientation to a horizontal orientation. The locking assembly 102 further comprises a stay 108 mounted on the plate 104 to restrict the rotation of the striker 106. A release handle 110 is fixed to the striker 106 and is configured to allow an operator to manually rotate the striker 106. FIG. 13 shows a side view of the conveyor skirting removal system 100 during rotation of the skirting panel 12. In FIG. 13(a), the skirting panel 12 is in a vertical orientation. FIG. 13(b) shows the skirting panel 12 as it is being rotated. In this frame, the upper portion 38 of the mounting member 36 impacts the striker 106, causing it to rotate until such a point where the upper portion may move past the striker 106. As shown in FIG. 13(c), once the skirting panel 12 has passed through the striker 106, the striker will return to its original position. In this orientation, the skirting panel 12 will impact the striker 106 if it is again moved back towards a vertical orientation. The stay 108 will prevent the striker 106 from rotating in the opposite direction, thereby restricting the about of movement possible by the skirting panel 12. When an operator wishes to move the skirting panel 12 back towards a vertical orientation, the release handle 110 is used to rotate the striker 106 to a position that allows the skirting panel to pass. The locking assembly 102 thereby ensure that the skirting panel 12 is not unintendedly moved back to a vertical orientation. It is envisaged that other types of locking mechanisms known in the art could be incorporated into the locking assembly 102. Locking mechanisms that allow one-way movement are advantageous as they will automatically engage once the skirting panel 12 has passed through it.

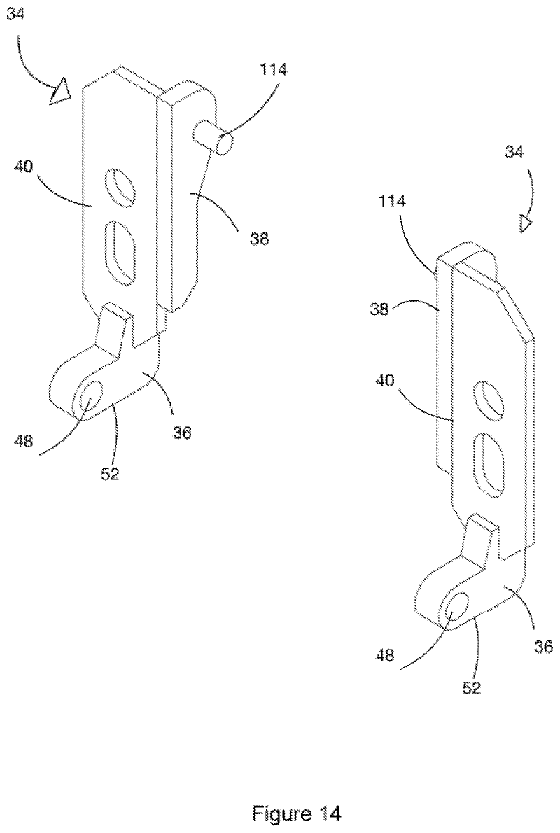

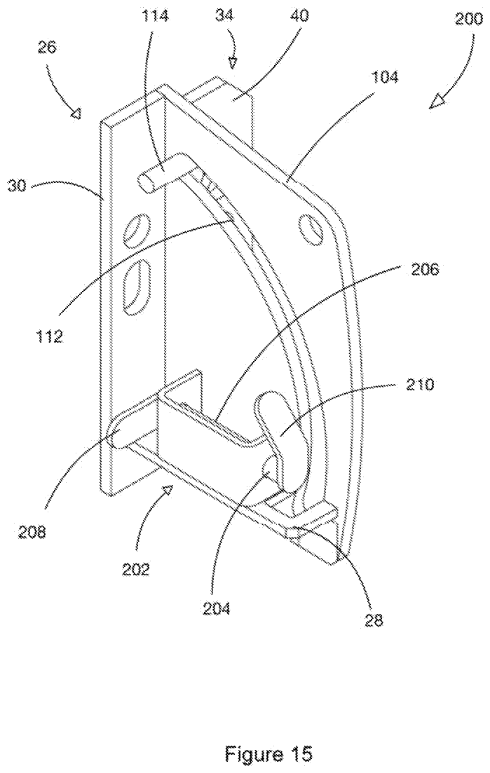

In the embodiment shown in FIGS. 11-14, the plate 104 further comprises a guidance slot 112. As best seen in FIG. 14, the mounting members 36 each comprise a projection 114. The projections 114 are configured to fit within the respective guidance slot. As the skirting panel 12 is rotated, the projections 114 move along the guidance slots 112. The rotation of the skirting panel 12 is limited by the termination of the guidance slot 112. At this point, the projections 114 will abut the end of the guidance slot 112. The use of the guidance slot 112 is intended to replace the use of the support portion 44 as described in the first embodiment. Similarly, the guidance slot 112 assists to ensure that when the skirting panel 12 is rotated back toward the vertical orientation, that the skirting panel 12 cannot rotate inwards of the skirt line. Guidance slot 112 also ensures the skirting panel 12 contacts the locking assembly 102 to ensure the locking engagement occurs. Persons skilled in the art will appreciate that numerous variations and modifications will become apparent. All such variations and modifications which become apparent to persons skilled in the art, should be considered to fall within the spirit and scope that the invention broadly appearing before described.

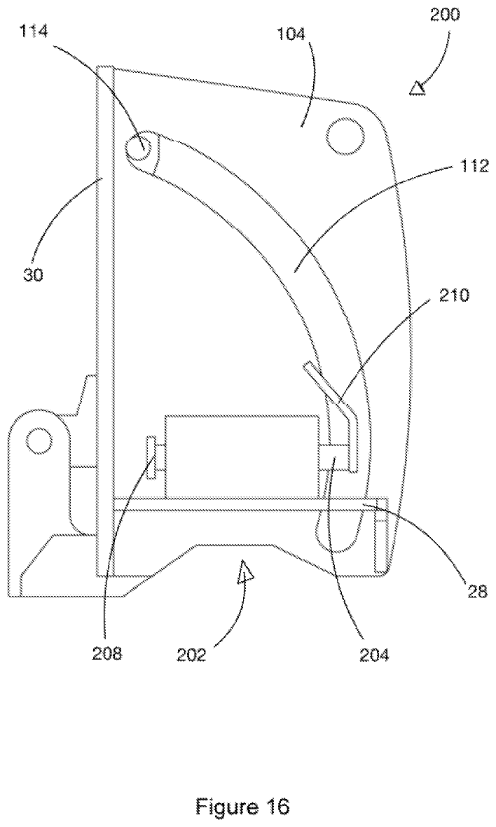

FIGS. 15 and 16 show a conveyor skirting removal system 200 in accordance with a further embodiment of the present invention which incorporates an alternative locking assembly 202. The locking assembly 202 is intended to allow the skirting panel 12 to be moved from a vertical orientation to a horizontal orientation, but restrict movement back to the vertical orientation until the locking assembly 202 is disengaged. Conveyor skirting removal system 200 shares many similarities with conveyor skirting removal system 200 and like numerals denote like parts.

FIGS. 15 and 16 show isolated views of locking assembly 202 incorporated into the support brackets 26. In this embodiment, one or each of the support brackets 26 further comprises a plate 104 fixed between the horizontal arm 28 and the vertical arm 30. The plate 104 is used to support the locking assembly 202 and provides a surface for it to be mounted on.

Locking assembly 202 comprises a pin 204, a spring mechanism 206 and a stop tab 208. Locking assembly 202 is configured to allow linear movement of the pin 204 between a lock position and an open position. The spring mechanism 206 is fixed to the pin 204 in an arrangement provides a bias towards the lock position. The stop bar 208 is fixed to the pin 204 and is configured to limit the linear movement of the pin 204 beyond the lock position and to prevent the pin 204 from being dislodged. The locking assembly 202 is positioned such that the locking assembly 20 will only allow the skirting panel 12 to move between a horizontal orientation and a vertical orientation when the pin 204 is the open position and prevent movement when in the lock position. In the embodiment shown in FIGS. 15 and 16, the plate 104 comprises a guidance slot 112 and the mounting members 36 each comprise a projection 114 that are configured to fit within the respective guidance slot. As the skirting panel 12 is rotated, the projections 114 move along the guidance slots 112. The locking assembly 202 is positioned such that the projection 114 will impact the pin 204 when in the lock position. It is envisaged that the locking assembly 202 could similarly positioned such that the any part of the skirting panel 12 or the support brackets 26 would impact pin 204 when in the lock position.

In the embodiment shown in FIGS. 15 and 16, locking assembly 202 further comprises a deflection plate 210 fixed to the pin 204. The deflection plate 210 is configured to move the pin 204 towards the open position as the skirting panel 12 is moved from a vertical orientation to a horizontal orientation. Once the skirting panel 12 has moved past the pin 204, the spring mechanism 206 will move the pin 204 back to the lock position, thereby preventing the rotation of the skirting panel 12 back to the vertical position. When an operator wishes to move the skirting panel 12 back towards a vertical orientation, a physical force is exerted on the pin 204 to manually move the pin 204 to an open position. The locking assembly 200 thereby ensures that the skirting panel 12 is not unintendedly moved back to a vertical orientation.

Persons skilled in the art will appreciate that numerous variations and modifications will become apparent. All such variations and modifications which become apparent to persons skilled in the art, should be considered to fall within the spirit and scope that the invention broadly appearing before described.

1. A conveyor skirting removal system, the system comprising:
a framework;
at least one skirting panel releasably fixed to the framework;
at least one set of support brackets, each support bracket comprising a rotation assembly and a horizontal arm extending laterally from the framework; and
at least one set of mounting members fixed to the skirting panel, each mounting member comprising a lower portion and an upper portion;
wherein the lower portion of each mounting member is configured to engage with the rotation assembly of one of the support brackets and the engagement permits rotational movement of the skirting panel to a position where the upper portion of each mounting member abuts the horizontal arm of one of the support brackets.

2. The conveyor skirting removal system according to claim 1, wherein each skirting panel has a wear liner attached thereto.

3. The conveyor skirting removal system according to claim 1, wherein a set of support brackets is mounted to the framework at the location of each skirting panel.

4. The conveyor skirting removal system according to claim 1, wherein the at least one set of support brackets is releasably mounted to the framework.

5. The conveyor skirting removal system according to claim 1, wherein a set of mounting members is fixed to each skirting panel.

6. The conveyor skirting removal system according to claim 1, wherein the set at least one set of mounting members is releasably mounted to the rear of the skirting panel.

7. The conveyor skirting removal system according to claim 1, wherein the lower portion of each mounting member comprises a rotation member configured to engage the rotation assembly of a support bracket.

8. The conveyor skirting removal system according to claim 1, wherein the rotation assembly comprises a pivot aperture configured to engage with a pin.

9. The conveyor skirting removal system according to claim 8, wherein the lower portion of each mounting member comprises a pin configured to co-operate with the pivot aperture.

10. The conveyor skirting removal system according to claim 1, wherein the rotation assembly comprises a pivot surface about which the mounting member may rotate.

11. The conveyor skirting removal system according to claim 10, wherein each mounting member comprises one or more teeth configured to engage with the pivot surface.

12. The conveyor skirting removal system according to claim 1, wherein the support brackets are configured to permit movement of the mounting members along the horizontal arm.

13. The conveyor skirting removal system according to claim 1, wherein at least one of the support brackets comprises a locking assembly configured to restrict rotation of the skirting panel from a horizontal position to a vertical position.

14. A system for removing skirting panels from a conveyor, the system comprising:
at least one set of support brackets releasably mountable to a framework of the conveyor, each support bracket comprising a rotation assembly and a horizontal arm extending laterally from the framework;
at least one set of mounting members releasably mountable to a rear face of a skirting panel, each mounting member comprising a lower portion and an upper portion;
wherein the lower portion of each mounting member is configured to engage with the rotation assembly of one of the support brackets and the engagement permits rotational movement of the skirting panel to a position where the upper portion of each mounting member abuts the horizontal arm of one of the support brackets.

15. A method for replacing a wear liner on a skirting panel of a conveyor, the method comprising the steps of:
engaging the system of claim 14 with the skirting panel;
unfastening the skirting panel from a framework of the conveyor;
rotating the skirting panel from a vertical orientation to a horizontal orientation;
replacing the wear liner;
rotating the skirting panel from a horizontal orientation to a vertical orientation; and
fastening the skirting panel to the framework.

16. The method according to claim 15, wherein engaging the system with the skirting panel comprises mounting the set of support brackets to a framework of the conveyor and mounting the set of mounting members to a rear face of a skirting panel.
